(19) United States
(12) Patent Application Publication
(10) Pub. No.: US 2018/0154382 A1
(43) Pub. Date: Jun. 7, 2018

(54) FILM FORMING METHOD AND FILM FORMING APPARATUS

(71) Applicant: NHK Spring Co., Ltd., Yokohama-shi (JP)

(72) Inventors: Satoshi Hirano, Kanagawa (JP); Koichi Kawasaki, Kanagawa (JP)

(21) Appl. No.: 15/575,499

(22) PCT Filed: Jun. 21, 2016
(86) PCT No.: PCT/JP2016/068433

§ 371 Date: Nov. 20, 2017

(30) Foreign Application Priority Data
Jun. 24, 2015 (JP) 2015-126742

(51) Int. Cl. B05B 7/16; C23C 24/04

(52) U.S. Cl. CPC B05B 7/1626; C23C 24/04

(57) ABSTRACT

A film forming method forms a film by spraying and depositing material powder in a solid phase state on a base member, and includes: adjusting, in accordance with a type of the material powder, a distance between: a position where a diameter of a through passage formed inside a nozzle is smallest, the diameter of the through passage decreases and thereafter increases from a base end toward a distal end; and a mixing position where the material powder introduced into the nozzle is mixed with gas; mixing the material powder with the gas in the mixing position, introducing the mixture into the nozzle, accelerating the mixture toward the position where the diameter is the smallest, and injecting the material powder and the gas from the distal end of the nozzle; and spraying the material powder and the gas injected from the distal end onto the base member.

### FIELD

The present invention relates to a film forming method and a film forming apparatus that implement a cold spray method.

### BACKGROUND

In recent years, a cold spray method is known as a method for forming a metal film (see Patent Literature 1, for example). The cold spray method is a film forming method by which material powder for the metal film is injected from a nozzle together with gas (either air or an inert gas) heated to a temperature equal to or lower than the melting point or the softening point of the powder so as to cause the powder to collide with a base member and to be deposited on a surface of the base member while the powder material remains in a solid phase state. When the cold spray method is used, because the processing is performed at temperatures lower than temperatures used in thermal spraying methods, it is possible to obtain a metal film that does not have a phase transformation and is inhibited from getting oxidized. Further, it is also possible to alleviate impacts of thermal stress. In addition, when the material of the base member and the material of the film are both metal, at the time of the collision of the material powder with the base member (or with a previously-formed film), an anchor effect is achieved because plastic deformation occurs between the powder and the base member. Also, because oxidized films formed on the powder and on the base member are destructed so that a metallic bond occurs between newly-generated surfaces, it is possible to form a film that has a high level of adhesion strength.

In a film forming apparatus that implements the cold spray method described above, generally speaking, a gas/powder mixing chamber used for mixing the material powder with high-pressure gas is provided on the upstream side of the nozzle. In the gas/powder mixing chamber, the powder and the high-pressure gas supplied from mutually-different systems are mixed with each other, so that the powder is injected from the tip end of the nozzle by gas pressure of the high-pressure gas.

### CITATION LIST

### Patent Literature

Patent Literature 1: Japanese Patent Application Laid-open No. 2008-302311

### SUMMARY

### Technical Problem

It is known that, to enhance the adhesion strength of a metal film, it is desirable to raise the injection speed of the powder. Generally speaking, to raise the injection speed of the powder, it is common practice to raise the temperature and the pressure of the gas to be injected together with the powder. However, when the temperature of the gas is raised too high, the powder gets heated excessively and is easily oxidized. Thus, a problem arises where the quality of the metal film is degraded due to deposition of oxidized powder.

Further, when a metal having a relatively low melting point is used as the material, raising the temperature of the gas too high softens the powder excessively or melts the powder. As a result, when the powder goes through the nozzle, the powder adheres to the inner wall of the nozzle, which makes the nozzle clogged easily. For this reason, in that situation, it is inappropriate to raise the injection speed of the powder by raising the temperature of the gas.

Further, when the temperature of the gas is raised too high, the base member with which the powder is to collide also gets heated and softened. There is a possibility that the part of the base member onto which the powder collides may be damaged. For example, even when the melting point of the powder is high, raising the injection speed of the powder by raising the temperature of the gas leads to a situation where the powder heated to a high temperature collides with the base member, and the base member is thus damaged. In particular, when the melting point of the base member is lower than the melting point of the powder, there is a possibility that this phenomenon may occur. For this reason, it is also inappropriate to raise the injection speed by raising the temperature of the gas to a level equal to or higher than the temperature at which the base member gets softened.

For these reasons, to form a metal film that has a high level of adhesion strength and has high quality, it is desirable to prevent the powder from being heated excessively, while raising the injection speed of the powder.

In view of the above circumstances, it is an object of an aspect of the present invention to provide a film forming method and a film forming apparatus that are capable of preventing the powder from being heated excessively, while raising the injection speed of the material powder.

### Solution to Problem

To solve the above-described problem and achieve the object, a film forming method according to the present invention is a method of forming a film by spraying and depositing material powder in a solid phase state on a surface of a base member, and includes: a mixing distance adjusting step of adjusting, in accordance with a type of the material powder, a distance between: a position where a diameter of a through passage formed inside a nozzle is smallest, the diameter of the through passage decreases and thereafter increases from a base end toward a distal end; and a mixing position where the material powder introduced into the nozzle is mixed with gas; an injecting step of mixing the material powder with the gas in the mixing position, introducing the mixture into the nozzle, accelerating the mixture toward the position where the diameter is the smallest, and injecting the material powder and the gas from the distal end of the nozzle; and a spraying step of spraying the material powder and the gas injected from the distal end onto the base member.

In the above-described film forming method, the mixing distance adjusting step decreases the mixing distance as a melting point of the material powder becomes low.

A film forming apparatus according to the present invention is an apparatus that forms a film by spraying and depositing material powder in a solid phase state on a surface of a base member, and includes: a mixing chamber where the material powder is mixed with gas; a nozzle configured to communicate, at a base end thereof, with the mixing chamber, the nozzle including a through passage formed therein, a diameter of the through passage decreases and thereafter increases from the base end toward a distal end, and being configured to inject the material powder and the gas mixed with each other in the mixing chamber from the distal end; a powder supply tube configured to supply the material powder to the mixing chamber; and a gas supply tube configured to supply the gas to the mixing chamber, wherein a distance between: a position where a diameter of the through passage is smallest; and a mixing position where the material powder and the gas are mixed with each other is variable.

In the above-described film forming apparatus, the powder supply tube is provided such that a tip end of the powder supply tube from which the material powder is injected protrudes from a rear end side of the mixing chamber toward the nozzle side, and a protruding amount of the tip end of the powder supply tube is variable.

In the above-described film forming apparatus, the powder supply tube is provided such that a tip end of the powder supply tube from which the material powder is injected protrudes from a rear end side of the mixing chamber toward the nozzle side, the film forming apparatus includes a plurality of tube-like members each of which is configured to form the mixing chamber, the tube-like members having different heights from each other, and the mixing chamber is formed by connecting one of the plurality of tube-like members to the base end of the nozzle.

In the above-described film forming apparatus, the mixing chamber is formed with a tube-like member connected to the base end of the nozzle, the tube-like member being provided with a plurality of powder supply ports provided along a longitudinal direction of a lateral face thereof, and the distance is varied by connecting the powder supply tube to one of the plurality of powder supply ports.

### Advantageous Effects of Invention

According to an aspect of the present invention, the distance between the mixing position where the material powder is mixed with the gas and the distal end of the nozzle injecting the powder together with the gas is adjusted in accordance with the type of the material powder. Accordingly, it is possible to inject the powder from the nozzle, before the material powder being in contact with the gas gets heated excessively. Consequently, it is possible to prevent the material powder from being heated excessively, while raising the injection speed of the material powder. It is therefore possible to form a metal film that has a high level of adhesion strength and has high quality, while inhibiting the powder from getting oxidized. In addition, because it is possible to prevent the powder from getting softened or melted by excessive heating of the powder, it is also possible to prevent the nozzle from being clogged by adhesion of the powder to the inner wall of the nozzle. Furthermore, because it is possible to inhibit the base member from getting softened by excessive heating of the powder, it is also possible to prevent the base member from being damaged when the powder is sprayed thereon.

### BRIEF DESCRIPTION OF DRAWINGS

FIG. 1 is a schematic drawing illustrating a configuration of a film forming apparatus according to an embodiment of the present invention.

FIG. 2 is an enlarged cross-sectional view of the interior of the spray gun illustrated in FIG. 1.

FIG. 3 is a cross-sectional view of an example in which a mixing distance is varied with respect to the spray gun illustrated in FIG. 2.

FIG. 4 is a flowchart illustrating a film forming method according to an embodiment of the present invention.

FIG. 5 is a chart illustrating a relationship among temperatures and speeds of material powder and mixing distances.

FIG. 6 is a cross-sectional view for explaining a lower limit value of the mixing distance.

FIG. 7 is a chart illustrating gas flow speeds (theoretical values) on the central axis of a nozzle.

FIG. 8 is a cross-sectional view of a part of a film forming apparatus according to a first modification example of the embodiment of the present invention.

FIG. 9 is a cross-sectional view of a part of a film forming apparatus according to a second modification example of the embodiment of the present invention.

FIG. 10 is a schematic drawing for explaining a simple tension testing method used for measuring a peeling strength.

FIG. 11 is a chart illustrating actual measured values of peeling strength in certain examples.

### DESCRIPTION OF EMBODIMENTS

Exemplary embodiments to carry out the present invention will be explained in detail below, with reference to the accompanying drawings. The present invention is not limited by the embodiments described below. Further, the drawings referenced in the following explanations merely illustrate shapes, sizes, and positional relationships in a schematic manner to such an extent that facilitates comprehension of the present invention. In other words, the present invention is not limited to the shapes, the sizes, and the positional relationships illustrated in the drawings.

### An Embodiment

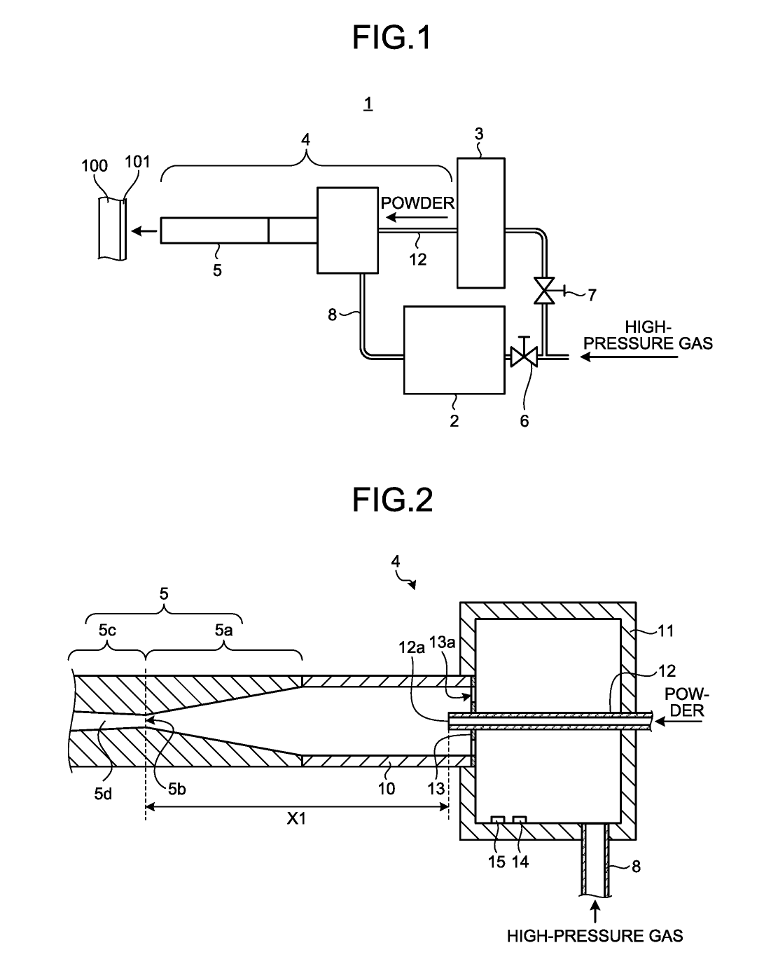

FIG. 1 is a schematic drawing illustrating a configuration of a film forming apparatus according to an embodiment of the present invention. As illustrated in FIG. 1, a film forming apparatus 1 according to the present embodiment is a film forming apparatus that implements a cold spray method and includes: a gas heater 2 that heats high-pressure gas (compressed gas); a powder supply device 3 that stores therein powder used as a film forming material and supplies the powder to a spray gun 4; the spray gun 4 that mixes the heated high-pressure gas with the powder and introduces the mixture to a nozzle 5; valves 6 and 7 that adjust the volume of the high-pressure gas supplied to the gas heater 2 and to the powder supply device 3, respectively; and a gas supply tube 8 that supplies the gas from the gas heater 2 to the spray gun 4. The spray gun 4 includes the nozzle 5 that injects the powder together with the high-pressure gas; and a powder supply tube 12 that supplies the powder to the spray gun 4.

As the high-pressure gas, air, which is inexpensive, or an inert gas such as helium or nitrogen may be used. The high-pressure gas supplied to the gas heater 2 is heated to a temperature in a range lower than the melting point of the material powder and is subsequently introduced to the spray gun 4 via the gas supply tube 8. The heating temperature of the high-pressure gas is preferably in the range of 150° C. to 900° C.

In contrast, the high-pressure gas supplied to the powder supply device 3 is used for supplying the powder stored in the powder supply device 3 to the spray gun 4 via the powder supply tube 12 so as to realize a predetermined discharge amount.

The high-pressure gas supplied from the gas heater 2 to the spray gun 4 is, while in the spray gun 4, mixed with the powder and the high-pressure gas supplied from the powder supply device 3 and is injected as a supersonic flow, as a result of passing through the nozzle 5. More specifically, when the high-pressure gas is either air or nitrogen in the range of 150° C. to 900° C., the flow speed at a throat part 5b is approximately in the range of 310 m/s to 600 m/s. As another example, when the high-pressure gas is helium in the range of 150° C. to 900° C., the flow speed at the throat part 5b is approximately in the range of 870 m/s to 1,630 m/s. Further, the flow speed of the gas in the vicinity of the exit of the nozzle 5 varies depending on the shape of a diameter increasing part 5c. More specifically, the larger the ratio of the cross-sectional area of the diameter increasing part 5c on the exit side to the cross-sectional area of the throat part 5b (which can be expressed as “the cross-sectional area on the exit side”/“the cross-sectional area of the throat part”) is, the higher is the flow speed observed in the vicinity of the exit.

It is preferable to arrange the pressure of the high-pressure gas in this situation to be approximately in the range of 0.3 MPa to 5 MPa. The reason is that, when the pressure of the high-pressure gas is adjusted to be at this level, it is possible to improve the adhesion strength of a film 101 to a base member 100. Even more preferably, the high-pressure gas may be processed with pressure approximately in the range of 3 MPa to 5 MPa.

In the film forming apparatus 1 configured as described above, while the base member 100 is arranged to face the spray gun 4, the material powder (either a metal or an alloy) is input to the powder supply device 3, and the high-pressure gas starts being supplied to the gas heater 2 and to the powder supply device 3. As a result, the powder supplied to the spray gun 4 is accelerated as being input into the supersonic flow of the high-pressure gas and is injected through the nozzle 5. As a result of the powder colliding with the base member 100 at a high speed and deposited while remaining in a solid phase state, the film 101 is formed.

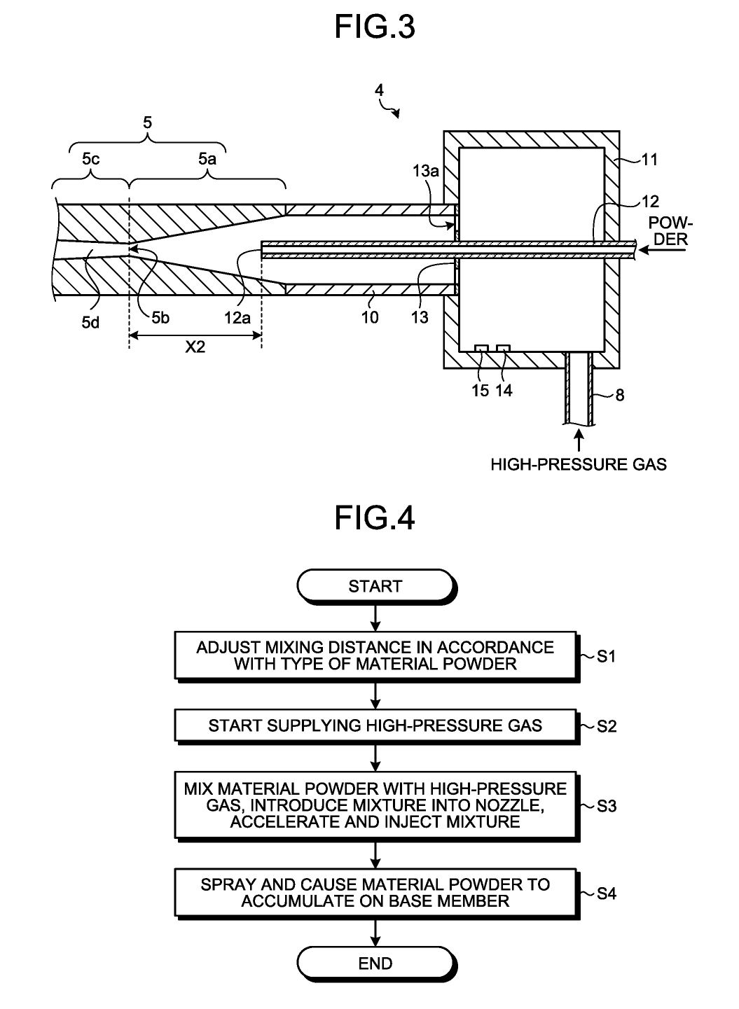

FIGS. 2 and 3 are enlarged cross-sectional views of the interior of the spray gun 4 illustrated in FIG. 1. As illustrated in FIG. 2, the spray gun 4 includes a gas/powder mixing chamber 10 connected to a base end of the nozzle 5; a gas chamber 11 filled with the high-pressure gas to be introduced to the gas/powder mixing chamber 10; the powder supply tube 12 that supplies the powder to the gas/powder mixing chamber 10; a powder supply tube supporting part 13 provided at the boundary between the gas/powder mixing chamber 10 and the gas chamber 11; and a temperature sensor 14 and a pressure sensor 15 provided inside the gas chamber 11. The powder supply tube supporting part 13 is provided with at least one gas passage port 13a that allows communication between the gas/powder mixing chamber 10 and the gas chamber 11.

The nozzle 5 is a so-called Laval nozzle that has, on the inside thereof, a through passage 5d communicating with the gas/powder mixing chamber 10 at a base end thereof and includes: a diameter decreasing part 5a in which the diameter of the through passage 5d decreases from the base end toward a distal end; the throat part 5b in which the diameter of the through passage 5d is the smallest; and the diameter increasing part 5c in which the diameter of the through passage 5d increases from the throat part 5b toward the distal end.

The gas/powder mixing chamber 10 is a mixing chamber formed by using a tube-like member of which the two ends are open and is used for mixing the high-pressure gas supplied from the gas chamber 11 with the powder supplied through the powder supply tube 12. More specifically, in a distal end of the powder supply tube 12, the powder injected out of the tip end of the powder supply tube 12 is mixed with the high-pressure gas introduced from the gas chamber 11 through the gas passage port 13a. In the following sections, the position of a tip end face 12a serving as an injection opening for the powder supplied through the powder supply tube 12 will be referred to as a “mixing position”. The powder mixed with the high-pressure gas is introduced into the nozzle 5 by the pressure of the high-pressure gas and is accelerated as a result of passing through the diameter decreasing part 5a.

Into the gas chamber 11, the heated high-pressure gas is introduced from the gas heater 2 via the gas supply tube 8. The pressure inside the gas chamber 11 is normally maintained approximately in the range of 0.3 MPa to 5 MPa. Due to the pressure difference between the inside of the gas chamber 11 and the inside of the gas/powder mixing chamber 10, the high-pressure gas is introduced into the gas/powder mixing chamber 10.

The powder supply tube 12 is arranged so as to extend through the gas chamber 11 in such a manner that the tip end thereof protrudes toward the nozzle 5 side, along the longitudinal direction of the gas/powder mixing chamber 10 and the nozzle 5. The length of the protrusion of the powder supply tube 12 is variable. For example, FIG. 2 illustrates an example in which the powder supply tube 12 is arranged so that the length of the protrusion is kept short and so that the tip end face 12a of the powder supply tube 12 stays in the vicinity of the base end of the gas/powder mixing chamber 10. FIG. 3 illustrates an example in which the powder supply tube 12 is arranged so as to protrude even to the inside of the diameter decreasing part 5a of the nozzle 5. By varying the length of the protrusion of the powder supply tube 12 in this manner, it is possible to adjust the distance between the position of the tip end face 12a (i.e., the mixing position) and the position of the throat part 5b. Hereinafter, the distance between the mixing position and the position of the throat will be referred to as a “mixing distance”. The mixing distance in FIG. 2 is X1, whereas the mixing distance in FIG. 3 is X2 (where X2<X1).

When the length of the protrusion of the powder supply tube 12 is extended (see FIG. 3), it is acceptable to arrange the powder supply tube supporting part 13 to be positioned inside of the gas/powder mixing chamber 10 for the purpose of stabilizing the position of the distal end of the powder supply tube 12. Alternatively, it is also acceptable to provide, separately from the powder supply tube supporting part 13, a member that supports the distal end of the powder supply tube 12 on the inside of the gas/powder mixing chamber 10.

Next, a film forming method according to an embodiment of the present invention will be explained. FIG. 4 is a flowchart illustrating the film forming method according to the embodiment of the present invention. Before the film forming process is started, the base member 100 on which the film 101 is to be formed is arranged in a predetermined position in the injecting direction of the nozzle 5, and also, the material powder used for forming the film 101 is input to the powder supply device 3.

First, at step S1, the mixing distance is adjusted in accordance with the type of the material powder. In the present embodiment, the mixing distance is adjusted by varying the length of the protrusion of the powder supply tube 12 protruding from the gas chamber 11.

The mixing distance is determined in accordance with the characteristics of the material itself such as the melting point thereof, the diameter of the material powder, the temperature and the pressure of the high-pressure gas, and the like. In a specific example, the lower the melting point of the material is, the shorter the mixing distance should be, because the material is more easily softened by the heating. Further, the more easily the material is oxidized, the shorter the mixing distance should be. Further, the smaller the diameter of the material powder is, the shorter the mixing distance should be, because the material is more easily heated due to a higher ratio of the surface area to the volume. Further, the higher the temperature of the high-pressure gas is, the shorter the mixing distance should be.

At the following step (step S2), the valves 6 and 7 are opened so as to start supplying the high-pressure gas to the gas chamber 11 via the gas heater 2, and also, to start supplying the high-pressure gas to the powder supply device 3.

At the following step (step S3), the material powder is mixed with the high-pressure gas, and the mixture is introduced to the nozzle 5, accelerated, and injected. More specifically, the material powder starts being supplied from the powder supply device 3 to the gas/powder mixing chamber 10. As a result, the material powder is mixed with the high-pressure gas at the mixing position in the gas/powder mixing chamber 10. The material powder is introduced to the nozzle 5 together with the flow of the high-pressure gas and is accelerated in the section from the diameter decreasing part 5a toward the throat part 5b. Further, the high-pressure gas reaches the sonic speed at the throat part 5b and further reaches a supersonic speed at the diameter increasing part 5c. While accelerating the material powder, the high-pressure gas is injected from the tip end of the nozzle 5.

At the following step (step S4), the material powder injected from the tip end of the nozzle 5 is sprayed and depositted on the base member 100. By continuously performing the process at step S4 on a desired region of the base member 100 for a desired period of time, it is possible to obtain the film 101 having a desired thickness.

Next, the mixing distance of the spray gun 4 illustrated in FIGS. 2 and 3 will be explained in detail. In the present embodiment, the mixing distance X is varied by adjusting the protruding amount of the powder supply tube 12 from the gas chamber 11, the mixing distance X denoting the distance from where the material powder is mixed with the high-pressure gas to where the material powder passes the throat part 5b. The reasons can be explained as follows.

When the cold spray method is used, the film 101 is formed by causing the material powder to collide with and to be deposited on the base member 100, while the material powder is in a solid phase sate. At the time of the collision, plastic deformation occurs between the powder and the base member 100. As a result, the anchor effect is achieved, and also, oxidized films formed on the powder and on the base member 100 are destructed so that a metallic bond occurs between newly-generated surfaces. For this reason, it is desirable to spray the material powder onto the base member 100 by accelerating the material powder to a high speed.

A method normally used for accelerating the material powder to a high speed is to increase the pressure and the temperature of the high-pressure gas injected together with the material powder. However, to form a film that is dense and has a high level of adhesion strength, it is necessary to prevent the material powder from being oxidized. Further, it is also necessary to prevent the powder from adhering to the inner wall of the nozzle and from melting, due to excessive heating. For these reasons, it is not desirable to heat the material powder excessively.

In view of these circumstances, in the present embodiment, the mixing distance of the spray gun 4 is arranged to be variable, so that it is possible to adjust the time period during which the material powder is in contact with the heated high-pressure gas. In other words, by varying the mixing distance in accordance with conditions such as the type of the material powder, the temperature of the high-pressure gas, and the like, the time period during which the material powder is in contact with the high-pressure gas is adjusted. With this arrangement, because it is possible to prevent the material powder from being heated excessively, it is possible to raise the temperature of the high-pressure gas to a higher level and to accelerate the material powder to a high speed.

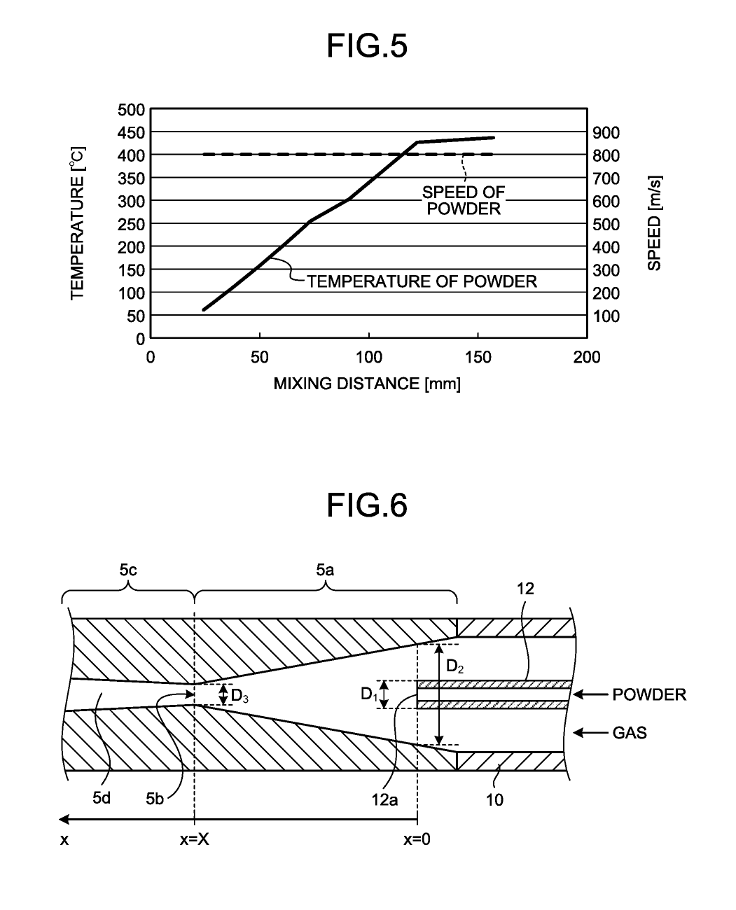

FIG. 5 is a chart illustrating a relationship among temperatures of the powder injected from the tip end of the nozzle 5 (the solid line), speeds of the powder (the broken line), and mixing distances. While using aluminum (melting point: approximately 660° C.; thermal conductivity 237 W/m·K) as the material powder, the chart was obtained by simulating temperatures and speeds of the powder while varying the mixing distance in the range from 24 mm to 157 m. The mixing distance 157 mm is the largest value for the spray gun 4 illustrated in FIG. 2.

As illustrated in FIG. 5, while the mixing distance is in the range from 24 mm to 157 mm, the speed of the powder hardly changes even when the mixing distance is varied. In contrast, when aluminum is used, while the mixing distance is in the range equal to or shorter than approximately 120 mm, it is observed that the shorter the mixing distance is, the more significantly the temperature of the powder is prevented from rising.

Next, a lower limit value of the mixing distance will be explained. FIG. 6 is a cross-sectional drawing for explaining the lower limit value of the mixing distance and illustrates the vicinity of the distal end of the nozzle 5 illustrated in FIGS. 2 and 3. As illustrated in FIG. 6, the outside diameter of the powder supply tube 12 is expressed as D₁, while the inside diameter of the nozzle 5 (the diameter of the through passage 5d) in the position of the tip end face 12a of the powder supply tube 12 is expressed as D₂, and the inside diameter of the nozzle 5 at the throat part 5b is expressed as D₃. Further, in the longitudinal direction of the nozzle 5, the tip end face 12a of the powder supply tube 12 is used as a reference position (x=0), and the direction extending from the reference position toward the tip end of the nozzle 5 will be referred to as “x direction”.

In that situation, it is possible to express the area Aₓ₌₀ of the cross-sectional plane through which the high-pressure gas is able to pass at the reference position (x=0), by using Expression (1) presented below.

$${A}_{x = 0} = ( {D}_{2}^{2} - {D}_{1}^{2} ) \cdot \frac{π}{4} \qquad ( 1 )$$

Further, it is possible to express the cross-sectional area A_{x=X} of the throat part 5b by using Expression (2) presented below.

$${A}_{x = X} = {D}_{3}^{2} \cdot \frac{π}{4} \qquad ( 2 )$$

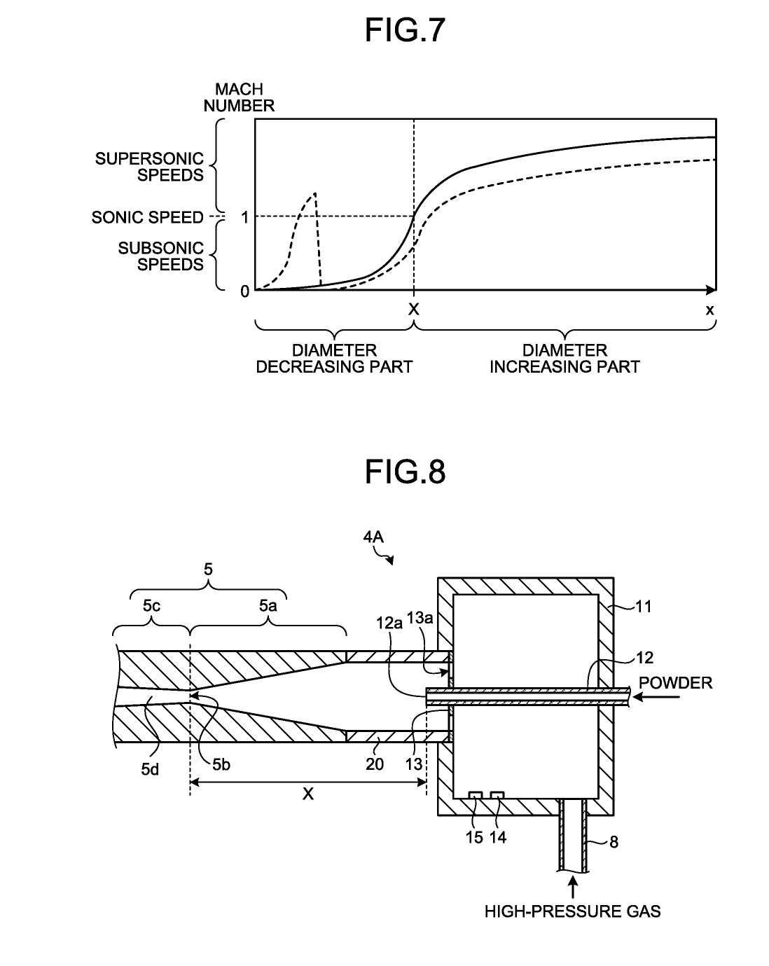

FIG. 7 is a chart illustrating gas flow speeds (theoretical values) on the central axis of the nozzle 5. In FIG. 7, the horizontal axis expresses the distance from the reference position (x=0) on the central axis, whereas the vertical axis expresses flow speeds (Mach numbers) of the high-pressure gas.

The solid line in FIG. 7 illustrates the flow speed of the high-pressure gas observed when the area Aₓ₌₀ of the cross-sectional plane through which the high-pressure gas is able to pass is larger than the cross-sectional area A_{x=X} of the throat part 5b (Aₓ₌₀>A_{x=X}). In that situation, the high-pressure gas enters the diameter decreasing part 5a of the nozzle 5 at the flow speed 0, and is subsequently accelerated gradually, until the flow speed reaches the sonic speed (Mach 1) at the throat part 5b where the cross-sectional area is the smallest. After that, the high-pressure gas is further accelerated in the diameter increasing part 5c and is injected from the tip end of the nozzle 5 at an ultrasonic speed.

In contrast, the broken line in FIG. 7 illustrates the flow speed of the high-pressure gas observed when the area Aₓ₌₀ of the cross-sectional plane through which the high-pressure gas is able to pass is smaller than the cross-sectional area A_{x=X} of the throat part 5b (Aₓ₌₀<A_{x=X}) i.e., when the tip end face 12a of the powder supply tube 12 is positioned close to the throat part 5b. In that situation, because the flow speed of the gas exceeds the sonic speed in the diameter decreasing part 5a that is positioned before the throat part 5b, a shock wave occurs.

However, because the diameter decreasing part 5a is designed to be suitable for flows at subsonic speeds, the diameter decreasing part 5a is impacted by an oblique shock wave caused on the wall surface of the diameter decreasing part 5a, when the supersonic gas passes through the diameter decreasing part 5a. Because the shock wave is not an isentropic flow, a loss is caused in the energy which the flow of the gas has, due the impact from the wall surface. As a result, the speed of the gas is lowered as illustrated by the broken line in FIG. 7.

Accordingly, to prevent the speed of the gas flow from being lowered, it is necessary to satisfy the condition (Aₓ₌₀>A_{x=X}) where the area Aₓ₌₀ of the cross-sectional plane through which the high-pressure gas is able to pass is larger than the cross-sectional area A_{x=X} of the throat part 5b. It means that the mixing distance X should be determined so as to satisfy this condition.

### First Modification Example

FIG. 8 is a cross-sectional view of a part of a film forming apparatus according to a first modification example of the embodiment of the present invention. The film forming apparatus according to the first modification example includes a spray gun 4A illustrated in FIG. 8, in place of the spray gun 4 illustrated in FIG. 2. The configurations of the constituent elements of the film forming apparatus other than the spray gun 4A are the same as those described in the above embodiment.

The spray gun 4A illustrated in FIG. 8 includes a gas/powder mixing chamber 20, in place of the gas/powder mixing chamber 10 included in the spray gun 4 illustrated in FIG. 2. The configurations of the constituent elements of the spray gun 4A other than the gas/powder mixing chamber 20 are the same as those described in the above embodiment.

The film forming apparatus according to the first modification example includes a plurality of tube-like members each of which is able to structure the gas/powder mixing chamber 20 and that have mutually-different heights. The gas/powder mixing chamber 20 is structured by connecting one of the tube-like members to the gas chamber 11 and to the base end of the nozzle 5. By replacing the tube-like member serving as the gas/powder mixing chamber 20 with another tube-like member having a different height, it is possible to vary the mixing distance X that is the distance between the mixing position represented by the position of the tip end face 12a of the powder supply tube 12 and the position of the throat part 5b.

### Second Modification Example

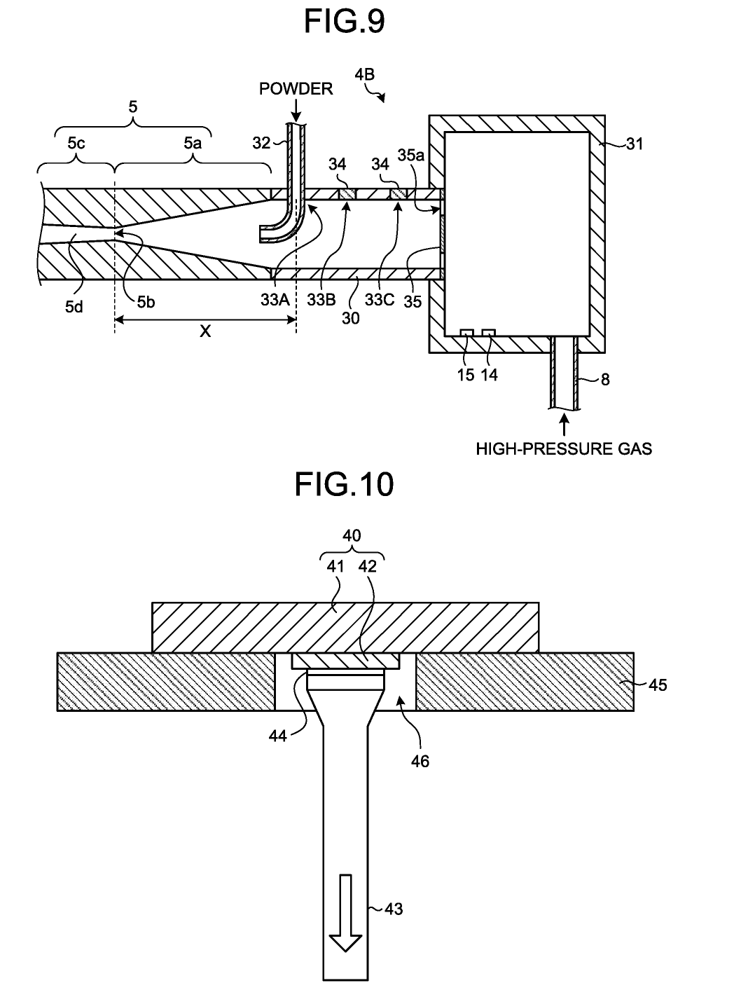

FIG. 9 is a cross-sectional view of a part of a film forming apparatus according to a second modification example of the embodiment of the present invention. The film forming apparatus according to the second modification example includes a spray gun 4B illustrated in FIG. 9, in place of the spray gun 4 illustrated in FIG. 2. The configurations of the constituent elements of the film forming apparatus other than the spray gun 4B are the same as those described in the above embodiment.

The spray gun 4B illustrated in FIG. 9 includes a gas/powder mixing chamber 30, a gas chamber 31, and a powder supply tube 32, in place of the gas/powder mixing chamber 10, the gas chamber 11, and the powder supply tube 12 illustrated in FIG. 2. The configurations of the constituent elements of the spray gun 4B other than the gas/powder mixing chamber 30, the gas chamber 31, and the powder supply tube 32 are the same as those described in the above embodiment.

The gas/powder mixing chamber 30 is configured with a tube-like member and has a plurality of through holes 33A, 33B, and 33C formed in a lateral face thereof, along the longitudinal direction thereof. The powder supply tube 32 can variably be connected to one of the through holes 33A, 33B, and 33C. FIG. 9 illustrates an example in which the powder supply tube 32 is connected to the through hole 33A that is positioned closest to the nozzle 5. Sealing plugs 34 are fitted into the through holes 33B and 33C to which the powder supply tube 32 is not connected, for the purpose of preventing leakage of the high-pressure gas and the powder. A distal end of the powder supply tube 32 is curved in such a manner that the injecting direction is parallel to the longitudinal direction of the nozzle 5 in the vicinity of the central axis of the gas/powder mixing chamber 30.

To the gas chamber 31, only the high-pressure gas is supplied via the gas supply tube 8. The high-pressure gas is introduced to the gas/powder mixing chamber 30 via at least one gas passage 35a that is provided in a partition member 35 configured to separate the gas chamber 31 from the gas/powder mixing chamber 30.

In the spray gun 4B configured as described above, when the high-pressure gas is supplied to the gas chamber 31, and also, the material powder is supplied to the powder supply tube 32, the material powder is mixed with the high-pressure gas in the vicinity of the through hole 33A to which the powder supply tube 32 is connected. In other words, the distance between the central axis of the through hole 33A and a plane including the throat part 5b is the mixing distance X. In the spray gun 4B configured in this manner, it is possible to vary the mixing distance X by switching the through hole to which the powder supply tube 32 is connected, among the through holes 33A, 33B, and 33C.

### Examples

By using the film forming apparatus 1 according to the embodiment described above, an experiment was performed to form an aluminum film on a copper base member.

### Experiment Conditions

As the material powder, aluminum powder configured with substantially spherical particles having an average particle diameter of approximately 30 μm was used. Further, as the high-pressure gas, nitrogen gas was heated to 450° C., pressurized to 5 MPa, and introduced to the gas chamber 11. As for the mixing distance X, the position of the powder supply tube 12 was adjusted along the x-direction to have three settings of 24 mm, 54 mm, and 157 mm.

(Evaluations)

Test pieces were produced by forming a 500-μm aluminum film on each of the copper base members having a size of 50 mm×50 mm×1.5 mm. The peeling strength was measured by pealing the aluminum film from each of the test pieces.

FIG. 10 is a schematic drawing for explaining a simple tension testing method used for measuring the peeling strengths. As illustrated in FIG. 10, on an aluminum film 42 side of a test piece 40 obtained by forming the aluminum film 42 on a copper base member 41, an aluminum pin 43 was fixed with the use of an adhesive agent 44. Further, on a fixation table 45 provided with a through hole 46, the test piece 40 was placed while the aluminum pin 43 was inserted through the through hole 46. The aluminum pin 43 was pulled downward, and the tensile force exerted at the time when the aluminum film 42 and the copper base member 41 were peeled off from each other was evaluated as a peeling strength.

(Results)

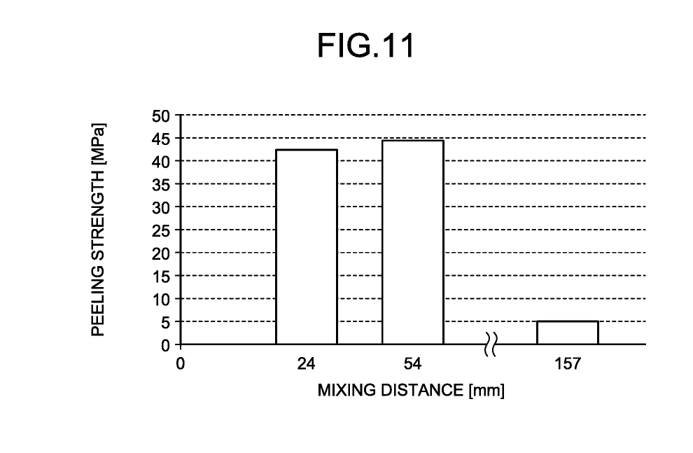

FIG. 11 is a chart illustrating the actual measured values of the peeling strengths. With reference to FIG. 5 presented above in comparison, when the mixing distance was 157 mm, the temperature of the powder increased to a level around 450° C. In contrast, when the mixing distance was 54 mm, the temperature of the powder stayed at a level around 150° C. When the mixing distance was 24 mm, the temperature of the powder stayed at a level around 60° C. As illustrated in FIG. 11, it is observed that the peeling strengths significantly increased as a result of shortening the mixing distance.

As explained above, according to at least one aspect of the present embodiment, by varying the mixing distance, it is possible to prevent the material powder from being heated excessively, while maintaining the speed of the material powder and the gas injected from the nozzle at a high level. As a result, because it is possible to inhibit the material powder from becoming soft or getting oxidized, it is possible to increase the peeling strength of the film deposited on the base member. It is therefore possible to produce a film that is dense and has high quality.

### REFERENCE SIGNS LIST

1 FILM FORMING APPARATUS
2 GAS HEATER
3 POWDER SUPPLY DEVICE
4, 4A, 4B SPRAY GUN
5 NOZZLE
5a DIAMETER DECREASING PART
5b THROAT PART
5c DIAMETER INCREASING PART
5d THROUGH PASSAGE
6, 7 VALVE
8 GAS SUPPLY TUBE
10, 20, 30 GAS/POWDER MIXING CHAMBER
11, 31 GAS CHAMBER
12, 32 POWDER SUPPLY TUBE
12a TIP END FACE
13 POWDER SUPPLY TUBE SUPPORTING PART
13a GAS PASSAGE PORT
14 TEMPERATURE SENSOR
15 PRESSURE SENSOR
34 SEALING PLUG
35 PARTITION MEMBER
40 TEST PIECE
41 COPPER BASE MEMBER
42 ALUMINUM FILM
43 ALUMINUM PIN
44 ADHESIVE AGENT
45 FIXATION TABLE
46 THROUGH HOLE
100 BASE MEMBER
101 FILM

1. A film forming method of forming a film by spraying and depositing material powder in a solid phase state on a surface of a base member, the film forming method comprising:
a mixing distance adjusting step of adjusting, in accordance with a type of the material powder, a distance between: a position where a diameter of a through passage formed inside a nozzle is smallest, the diameter of the through passage decreases and thereafter increases from a base end toward a distal end; and a mixing position where the material powder introduced into the nozzle is mixed with gas;
an injecting step of mixing the material powder with the gas in the mixing position, introducing the mixture into the nozzle, accelerating the mixture toward the position where the diameter is the smallest, and injecting the material powder and the gas from the distal end of the nozzle; and
a spraying step of spraying the material powder and the gas injected from the distal end onto the base member.

2. The film forming method according to claim 1, wherein the mixing distance adjusting step decreases the mixing distance as a melting point of the material powder becomes low.

3. A film forming apparatus that forms a film by spraying and depositing material powder in a solid phase state on a surface of a base member, the film forming apparatus comprising:
a mixing chamber where the material powder is mixed with gas;
a nozzle configured to communicate, at a base end thereof, with the mixing chamber, the nozzle including a through passage formed therein, a diameter of the through passage decreases and thereafter increases from the base end toward a distal end, and being configured to inject the material powder and the gas mixed with each other in the mixing chamber from the distal end;
a powder supply tube configured to supply the material powder to the mixing chamber; and
a gas supply tube configured to supply the gas to the mixing chamber, wherein
a distance between: a position where a diameter of the through passage is smallest; and a mixing position where the material powder and the gas are mixed with each other is variable.

4. The film forming apparatus according to claim 3, wherein
the powder supply tube is provided such that a tip end of the powder supply tube from which the material powder is injected protrudes from a rear end side of the mixing chamber toward the nozzle side, and
a protruding amount of the tip end of the powder supply tube is variable.

5. The film forming apparatus according to claim 3, wherein
the powder supply tube is provided such that a tip end of the powder supply tube from which the material powder is injected protrudes from a rear end side of the mixing chamber toward the nozzle side,
the film forming apparatus includes a plurality of tube-like members each of which is configured to form the mixing chamber, the tube-like members having different heights from each other, and
the mixing chamber is formed by connecting one of the plurality of tube-like members to the base end of the nozzle.

6. The film forming apparatus according to claim 3, wherein
the mixing chamber is formed with a tube-like member connected to the base end of the nozzle, the tube-like member being provided with a plurality of powder supply ports provided along a longitudinal direction of a lateral face thereof, and
the distance is varied by connecting the powder supply tube to one of the plurality of powder supply ports.
